(19) United States
(12) Patent Application Publication
(10) Pub. No.: US 2024/0037649 A1
(43) Pub. Date: Feb. 1, 2024

(54) Level Playing Field Lending Model

(71) Applicant: Adrayll ASKEW, Farmers Branch, TX (US)

(72) Inventor: Adrayll ASKEW, Farmers Branch, TX (US)

(21) Appl. No.: 17/882,528

(22) Filed: Aug. 5, 2022

Related U.S. Application Data
(60) Provisional application No. 63/393,878, filed on Jul. 30, 2022.

(51) Int. Cl. G06Q 40/02

(52) U.S. Cl. CPC G06Q 40/025

(57) ABSTRACT

Disclosed methods and systems perform initial phase operations and one or more iterations of construction phase operations to evaluate a loan regarding a proposed project for a property. The initial phase operations, which determine a value for an initial phase lending metric, include determining a funded-at-close (FAC) amount and a value-at-close (VAC) of the property and calculating the initial phase lending metric based on the FAC and the VAC. If the initial phase lending metric value fails to satisfy an initial phase lending criteria, disclosed methods may terminate. Otherwise, the process may continue to one or more iterations of construction phase operations. Disclosed construction phase operations may use the ARV of the proposed project in the calculation and evaluation of construction phase metrics. Thus, disclosed methods and systems determine an after-repair-value (ARV) for the propose project prior to performing the construction phase operations.

### TECHNICAL FIELD

The present disclosure relates to commercial lending and, more specifically, commercial lending for non-QM (qualifying mortgage) loans for owner-occupied properties.

### BACKGROUND

Historically, real estate lending models for non-QM lending on owner-occupied properties have relied heavily on a single, conventional loan to value (LTV) metric, i.e., the dollar amount of the loan relative to the as-is value of the property. FIG. 1 illustrates an exemplary closing document 100 for an exemplary owner-occupied project with an after repair value of $899,000 that produces a negative loan determination by assessing the loan using the single metric approach. Specifically, the exemplary loan document 100 indicates (102) the borrow must provide in excess of $172,000 at closing as a precondition of the loan despite the fact the borrower is contributing the owner-occupied property, valued at $199,000 (104) on which the conventional loan process places zero value for purposes of approving the loan.

### SUMMARY

The following subject matter discloses a financial lending model referred to herein as a level playing field (LPF) model, suitable for various use cases including automated systems and methods providing lending determinations regarding non-qualifying mortgage (non-QM) bridge loans, either new construction or fix/flip, for owner-occupied residential properties. A disclosed LPF model provides a lending determination based on a multi-stage process that evaluates lending metrics and lending criteria for each of two or more stages in the construction of a proposed project using two or more distinct valuations. In at least one embodiment, a disclosed LPF model evaluates a proposed loan at an initial stage, e.g., closing, and one or more construction stages. Importantly, metrics determined during the one or more construction stage phases use an after repair value (ARV) valuation that produces a more accurate indication of business risk than conventional lending programs that rely exclusively or heavily on a property's as-is value.

In addition, disclosed LPF models are based on loan amounts that include funding for up to 24 months of prepaid rent/lease payments for alternative housing, plus move out expenses, back taxes, project initiation costs, and other expenses that are likely to arise with an owner-occupied project. Incorporating such costs in the underlying loan beneficially improves the reliability of the loan determination by recognizing the reality that an owner-occupied project is more likely to conclude successfully when consequential but unavoidable expenses associated with owner-occupied projects are provided via the loan and included in the lending model.

The first stage of the model, referred to herein as the pre-construction stage, makes an initial lending decision based on actual loan amount funded at close and loan amount to begin the construction project in that first stage, relative to the value of the contributed owner-occupied property. This Loan to Cost (LTC) is a more accurate view of the credit risk and capital at risk at that stage.

The next stage of the model, referred to herein as the construction state, is based on the property ARV and calculates a Loan to Value (“LTV”) based on the specific use of proceeds, in addition to the new home construction or rehab costs compared to the After Repair Value (“ARV”).

The LPF model provides the homeowner greater access to the full equity value in their property in exchange for using the property as security for the Non-QM loan, as is standard lending practice. The LPF model uncovers and corrects the issues that create an inefficient market in Non-QM residential real estate investing by improving credit risk modeling, credit underwriting and approval.

In at least some embodiments, the LPF lending model includes 12 months of prepaid rent/lease payments for alternative housing, plus move out expenses, back taxes, project initiation costs, and other homeowner expenses into the use of the Non-QM loan proceeds at closing. This allows homeowners with owner-occupied properties to contribute the full equity value that they have in the property, lot and land which represents the As-Is-Value of the owner-occupied property. In the creation of a Non-QM loan model and product, this is accomplished by temporarily relocating the borrower out of the owner-occupied property to allow the homeowner to execute a full rehab or new construction project of a home on the lot or existing property that the homeowner actually currently resides in.

The LPF model allows the lender to make a lending decision using an LTV based on ARV of a completed new construction home or fully rehabbed home on the borrower's property. The use of ATV value is appropriate at least in part because the risk of not completing a project after a funding decision is made can be controlled and minimized using specific, careful, and controlled builder selection. This model allows a more accurate risk analysis, collateral and credit decision to be made that levels the playing field in Non-QM residential real estate lending between owner-occupied properties and the non-owner-occupied properties of real estate investors.

Previous real estate investment lending models used in practice for Non-QM lending on owner-occupied properties did not allow the inclusion of the following:
1) The allowance of up to 24 months of pre-paid rent and moving out and back in expenses for the homeowner and prospective borrower to be included in the use of funds for the loan at closing. This is done on a fully secured basis and at a low LTV.
2) The inclusion of a 24 month interest reserve funded upfront for the prospective borrower to be included in the use of funds for the loan at closing. This allows the borrower to pay the loan interest payments during the 24 month construction project. This also reduces risk for the lender while allowing the borrower to access the necessary funds using the full equity value of the assumed completed construction project, based on the ARV. This is also done on a fully secured basis and at a low LTV.
3) A Loan to Value (“LTV”) based on the After Repair Value (“ARV”) of the owner-occupied property, instead of using Loan to Cost (“LTC”) on the As-Is-Value or Cost. This lending model allows the owner to access their full home equity value by evaluating the timing of the loan cash flows, the structure and timing of the construction project, and other risk mitigants that also include builder selection and construction draws. Previously, only non owner-occupied real estate investors were allowed to borrow based on the ARV of the property. This is the Non-QM lending model that allows homeowners of owner-occupied properties to receive this important benefit, just as investors do.

This benefit ultimately results in greater loan proceeds to the homeowner and better ability to use leverage, resulting in greater flexibility and investment options. In addition, this allows the lender to make a more accurate decision based on the collateral value of the finished constructed home, given the control mechanisms in place on the construction project. Thus, this levels the playing field between residential homeowners looking to invest in their own property and residential real estate investors.
4) A multi-period calculation of LTV based on actual loan and borrower cash flows, as opposed to a single period calculation of the LTV. This allows a lender to have an accurate representation of the cash flows out for the loan, the risks and mitigants involved in the multi-year rehab or new construction project. It better reflects reality, in which lending exposure and construction draws are multi-staged. These mitigants allow the lender many opportunities for loan funding risk mitigation over time.

The model takes into consideration the funding control and the collateral the secured lender has due to the multi-stage funding draws and construction inspections that occur prior to additional funding over the life of the rehab project or new construction real estate project. In addition, the methodology of the LPF-model loan product requires the borrower to select a builder from the lender's approved builder list. This further mitigates completion and construction risk for the lender and borrower.
4) An ability of the borrower to refinance into a long term Non-QM loan based on the ARV and a new appraised value once the new construction or rehab project has reached its completion at 24 months. This reduces risk for the borrower and lender at closing of an LPF-model loan. This is done on a fully secured basis and at a low LTV.

In one aspect, disclosed LPF lending methods and systems perform initial phase operations and one or more iterations of construction phase operations to evaluate a loan regarding a proposed project for a property. The initial phase operations, which determine a value for an initial phase lending metric, include determining a funded-at-close (FAC) amount and a value-at-close (VAC) of the property and calculating the initial phase lending metric based on the FAC and the VAC. If the initial phase lending metric value fails to satisfy an initial phase lending criteria, disclosed methods may terminate. Otherwise, the process may continue to one or more iterations of construction phase operations.

In at least some embodiments, disclosed construction phase operations use the ARV of the proposed project in the calculation and evaluation of construction phase metrics. Thus, disclosed methods and systems determine an after-repair-value (ARV) for the propose project prior to performing the construction phase operations. After determining the proposed project's ARV, disclosed methods and systems perform one or more iterations of construction phase operations corresponding to one or more construct phase dates to determine one or values for a construction phase metric. In at least some embodiments, the construction phase operations include determining a funded-to-date (FTD) amount and calculating the construction phase lending metric based on the FTD and the ARV. If none of the responsive to determining that none of the one or more construction phase lending metrics fails to satisfy a construction phase lending criteria a determination to fund the loan may be made.

In at least some embodiments, the loan under consideration is a non-QM loan for a new construction or fix and flip bridge loan on an owner-occupied property. The loan assumed and evaluated by the model may incorporate a living expense component, a collateral expense component, or both. The living expense component may provide for an owner's monthly living expense during the construction phase and may, in at least some embodiments, include 12 month of prepaid rent. In such cases, the FAC used during the initial phase operations and the FTD used during construction phase operations may include this amount or a portion of this amount, e.g., a pro rata percentage.

In at least some embodiments, the loan may incorporate a collateral expense component included in the FAC and FTD. The collateral expense component may include, as non-limiting examples, a moving expense providing for an owner's moving expense before the construction phase, a back taxes expense, and a projection initiation expense.

For purposes of clarity and brevity, the detailed description to follow may emphasize non-QM bridge loans for new construction or fix/flip of owner-occupied properties. Those of ordinary skill in the applicable field will, however, recognize that disclosed teachings are not limited by descriptions of specific illustrative examples.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates aspects of a conventional lending model;

FIG. 2 illustrates a flow diagram of an LPF lending model in accordance with disclosed teachings;

FIG. 3 and FIG. 4 illustrate hypothetical closing documents for an example loan evaluated with an LPF lending model; and

FIG. 5 illustrates an example system suitable for use in conjunction with disclosed subject matter.

### BRIEF DESCRIPTION OF THE DRAWINGS

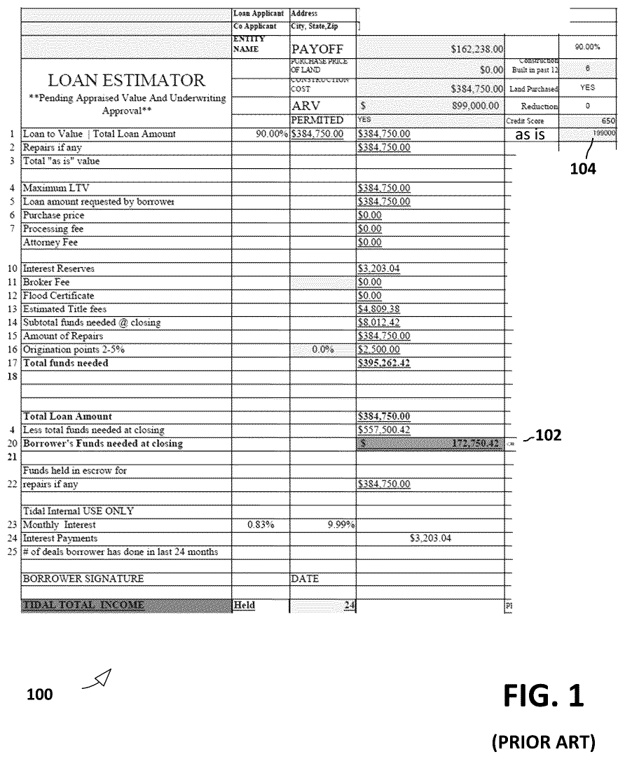

Exemplary embodiments and their advantages are best understood by reference to FIGS. 1-5, wherein like numbers are used to indicate like and corresponding parts unless expressly indicated otherwise.

For the purposes of this disclosure, a system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, a system may be a personal computer, a personal digital assistant (PDA), a consumer electronic device, a network storage device, or any other suitable device and may vary in size, shape, performance, functionality, and price. The system may include memory, one or more processing resources such as a central processing unit (“CPU”), microcontroller, or hardware or software control logic. Additional components of the system may include one or more storage devices, one or more communications ports for communicating with external devices as well as various input/output (“I/O”) devices, such as a keyboard, a mouse, and a video display. The system may also include one or more buses operable to transmit communication between the various hardware components.

Additionally, a system may include firmware for controlling and/or communicating with, for example, hard drives, network circuitry, memory devices, I/O devices, and other peripheral devices. For example, the hypervisor and/or other components may comprise firmware. As used in this disclosure, firmware includes software embedded in a system component used to perform predefined tasks. Firmware is commonly stored in non-volatile memory, or memory that does not lose stored data upon the loss of power. In certain embodiments, firmware associated with a system component is stored in non-volatile memory that is accessible to one or more system components. In the same or alternative embodiments, firmware associated with a system component is stored in non-volatile memory that is dedicated to and comprises part of that component.

For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of a system, including without limitation processors, service processors, basic input/output systems (BIOSs), buses, memories, I/O devices and/or interfaces, storage resources, network interfaces, motherboards, and/or any other components and/or elements of a system.

In the following description, details are set forth by way of example to facilitate discussion of the disclosed subject matter. It should be apparent to a person of ordinary skill in the field, however, that the disclosed embodiments are exemplary and not exhaustive of all possible embodiments.

Throughout this disclosure, a hyphenated form of a reference numeral refers to a specific instance of an element and the un-hyphenated form of the reference numeral refers to the element generically. Thus, for example, “device 12-1” refers to an instance of a device class, which may be referred to collectively as “devices 12” and any one of which may be referred to generically as “a device 12”.

As used herein, when two or more elements are referred to as “coupled” to one another, such term indicates that such two or more elements are in electronic communication, mechanical communication, including thermal and fluidic communication, thermal, communication or mechanical communication, as applicable, whether connected indirectly or directly, with or without intervening elements.

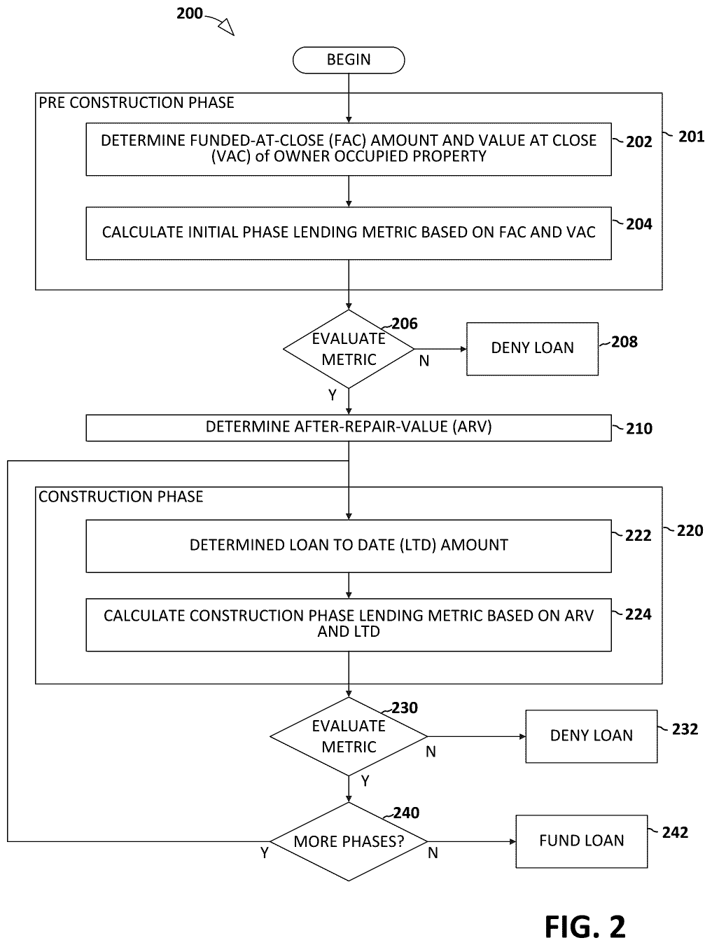

Referring now to FIG. 2, a flow diagram illustrates a method, referred to herein as LPF method 200, in accordance with disclosed subject matter, suitable for use in making lending determinations, regarding various owner-occupied development projects, based on valuations that accurately reflect the capital contributed by the owner-occupant borrower, as well as the risk assumed by the lender. For purposes of this disclosure, an owner-occupied project includes any real estate development project, including new construction and improvement projects, in which the borrower owns and/or occupies that property to be developed.

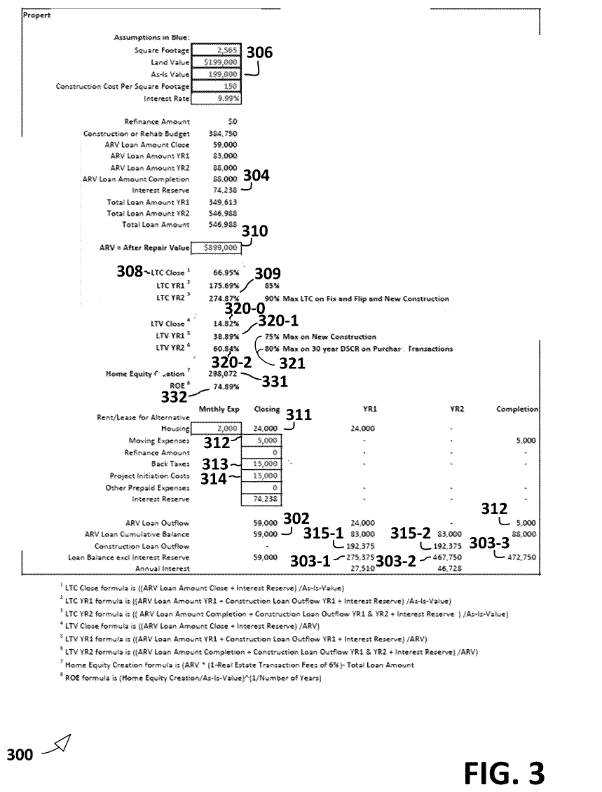

The LPF method 200 illustrated in FIG. 2 includes performing (step 201) initial phase operations to determine a value for an initial phase lending metric. As depicted in FIG. 2 initial phase operations 201 include determining (step 202) a funded-at-close (FAC) amount and a value-at-close (VAC) associated with a loan on a proposed owner-occupied project. In at least some embodiments, the FAC includes the at-close loan disbursements plus a reserve for the interest applicable to the proposed loan. Referring, for purpose of illustration, to an exemplary closing statement 300 depicted in FIG. 3, the FAC for the illustrated loan includes $49,000 of funds (302) dispersed at closing plus an interest reserve (304) of approximately $74,238 for a total of $133,238. The VAC for the illustrated loan is the $199,000 as-is value (306) of the owner-occupied property, which reflects the value of capital contributed by the borrower as collateral for the loan. Those of ordinary skill in the field of real estate lending and finance will appreciate that conventional lending models fail to consider the as-is value of owner-occupied property in the lending determination.

After determining an FAC and VAC for a proposed project, the method 200 depicted in FIG. 2 calculates (step 204), based on the FAC and VAC, a value for an initial phase lending metric. The initial phase lending metric is evaluated (step 206) against a lending criteria, such as a maximum permitted at-close LTC.

In the example closing document 300 depicted in FIG. 3, the initial phase lending metric (308) is referred to as the loan-to-cost (LTC) at close, which is equal to FAC/VAC or, in the illustrated example, 66.94%. Calculating initial phase lending metric (308) based on the actual at-closed value of the owner-occupied property at-close disbursements of funds results in metric that accurately reflects the at-close risk to the lender.

Returning to FIG. 2, the illustrated method proceeds by evaluating (step 206) the initial phase lending metric, e.g., LTC at close, against a predetermined criteria, typically expressed as a maximum value of the applicable metric. If the initial phase lending metric satisfies the initial phase lending criteria, the illustrated method 200 continues on to perform one or more construction phase operations, as described below. If the initial phase lending metric fails to satisfy an initial phase lending criteria, the lender may decline the loan and method 200 may terminate.

The construction phase operations of the method 200 illustrated in FIG. 2 begin with the determination (step 210) of an ARV associated with the proposed project. In the depicted example of method 300, the ARV of a proposed project may be used as the valuation for each of one or more iterations of the construction phase operations, including iterations that correspond to pre-completion intervals of the construction project. The use of ARV during pre-completion construction phases of a project is consistent with the likelihood that the actual construction of the project will be completed once the decision to fund the project is made. In addition, the likelihood of successful project completion can be managed by the lender via careful selection and monitoring of contractors, etc. Referring again to the example closing document 300 of FIG. 3, the ARV (310) for the depicted document is $899,000, which may be determined in accordance with any of suitable real estate valuation methodology including methodologies based on current market values as reflected in recent comparable sales.

After determining the project's ARV, the illustrated method 200 includes one or more iterations of construction phase operations 220. The number of iterations, i.e., the number of times the construction phase operations 220 are performed is a factor of the length of a proposed construction project and the frequency of loan disbursements. For the sake of clarity and brevity, a proposed project is expected to complete in 2 years and loan disbursements are annually, i.e., disbursement are made at close, at the end of year 1, and at the completion of the project at the end of year 2. These assumptions are exemplary and are readily adaptable to construction projects with longer or shorter completion times and disbursement schedule with more frequent, less frequent, and/or non-periodic disbursements.

Each iteration of the construction phase operations 220 depicted in FIG. 2 include a determination (step 222) of a loan to date (LTD) value, which reflects all loan disbursements through the applicable date, and the calculation (step 224) of a construction phase lending metric. In at least some embodiments, the construction phase lending metric may be an LTV metric based on the ARV and the applicable value of LTD.

The exemplary closing document 300 of FIG. 3 illustrates values of LTD 303 for each phase of the project. For the 2-year project of the illustrated example with annual disbursements, the LTD value 303-1 reflects the LTD corresponding to year 1 of the project, LTD 303-2 reflects the LTD corresponding to year 2 of the project, and LTD 303-3 reflects the LTD at completion, including any post-construction costs such as the $4,000 moving expense cost 312 illustrated in closing document 300. Each value of LTD 303 includes the sum of all disbursements, including the collateral disbursements corresponding to living expense 311, moving expense 312, back taxes 313, and project initiation costs 314, as well as the actual loan construction disbursements 314 through the applicable period plus the interest reserve. The disbursements at each phase including the at-close disbursements.

After each iteration of construction phase operations 220, the LPF method 200 illustrated in FIG. 2 evaluates (operation 230) the applicable metric against a lending criteria such as LTV or some variation of LTV. The example closing document 300 illustrates ARV-based LTV values at closing (320-0), year 1 (320-1), and year 2 (320-2) with corresponding criteria or maximum values 321 corresponding to the year 1 and year 2 LTV values. As seen in FIG. 3, using the ARV for LTV determinations results in LTV values safely below the applicable criteria at each phase of the construction.

The LTC at Close (308) is below the typical 80-90% Max Limit. Note that the LTC using the single-stage model would arrive at a figure roughly equal to the LTC YR2 FIG. (309), which is well above the 80-90% Max limit. As a result, the loan would be declined or the loan applicant would be required to contribute significant cash at closing, as was seen in the example illustrated in FIG. 1. This cash at closing would be in in addition to the applicant's contribution of the owner-occupied property.

The LTV at Close (320-0) based on the ARV is well below the typical 64-74% max limit. Note that the LTV using the single-stage model would arrive at a figure roughly equal to the LTV YR2 FIG. 320-2, which does not accurately reflect the actual disbursements of loan proceeds. In contrast, the LTV Close and LTV YR1, which are more accurate because they are calculated based on actual disbursements of loan proceeds, are much lower. The single-stage model overestimates the early period LTV, leverage, and capital at risk in the lending decision and fails to acknowledge the reality that the lender can limit its risk with respect to YR2 disbursements in the event that completion of the projection becomes unlikely.

With the LTC at Close (308) well below the typical 80-90% Max limit, the actual leverage of the project at closing is at an approvable level. Once the construction or rehab project begins, the correct value metric to use is the ARV, not only because both parties to the loan have an incentive to complete it, but also because the lender can significantly influence the likelihood of completion, i.e., limit its risk, by selecting experienced contractors and carefully managing the project. Calculated based on ARV, the LTV YR1 (320-1) and LTV YR2 (320-2) are both below the 74% or 80% LTV Max limit. In contrast, a single-stage model will typically require the loan applicant to contribute cash at closing in addition to the existing owner-occupied property whereas the LPF model typically does not. Note that the value of the owner-occupied property is not limited to the owner-occupant's at-closing equity in the property, i.e., the as-is value less the payoff balance of all pre-existing mortgages on the property, because the owner-occupant is the only party who can unilaterally decide not to pursue the project. In this respect, the owner-occupant possess a valuable option that is not recognized by single-stage models.

LPF models disclosed herein beneficially allow the borrow to roll consequential expenses, i.e., expenses that are a direct result of pursuing the project, into the loan amount. In addition to providing a more accurate assessment of the loan applicant's true costs, the inclusion of consequential costs helps to ensure that the project will not fail for consequential reasons such as the applicant's inability to pay rent for temporary housing during construction. In this manner, the LPF model truly levels the playing field for owner-occupant borrowers. These consequential expenses may include any one or more of the following, expenses, among others:
Alternative housing expenses
Moving Expenses
Debt refinance expenses
Back taxes
Project initiation costs
An interest reserve
Prepaid expenses

Single-stage models may detrimentally dismiss or ignore consequential expenses, potentially resulting in a “false positive” determination in which, a loan application evidencing an acceptable LTV is actually a potentially risky loan when consequential expenses are considered.

FIG. 4 illustrates an exemplary investment analysis document 400 generated after successful completion of the project and subsequent sale of the property. The illustrated document 400 conveys various favorable values for applicable metrics including net profit 401, return on investment (ROI) 402, and cash on cash return 403, each of which will be recognizable to those of ordinary skill. Similarly, FIG. 3 conveys a favorable equity creation metric 331 and a return on equity (ROE) 332.

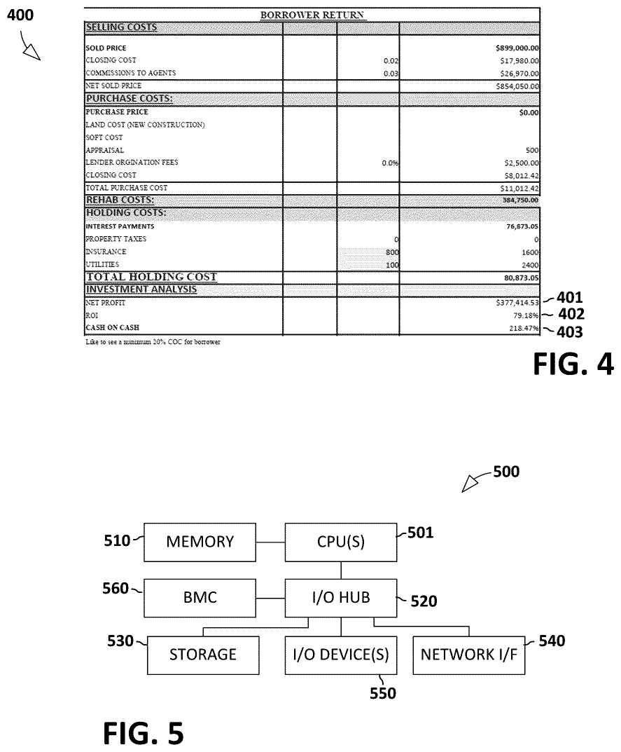

Referring now to FIG. 5, any one or more of the elements illustrated in FIG. 1 through FIG. 2 may be implemented as or within a system exemplified by the information handling system 500 illustrated in FIG. 5. The illustrated system includes one or more general purpose processors or central processing units (CPUs) 501 communicatively coupled to a memory resource 510 and to an input/output hub 520 to which various I/O resources and/or components are communicatively coupled. The I/O resources explicitly depicted in FIG. 5 include a network interface 540, commonly referred to as a NIC (network interface card), storage resources 530, and additional I/O devices, components, or resources 550 including as non-limiting examples, keyboards, mice, displays, printers, speakers, microphones, etc. The illustrated system 500 includes a baseboard management controller (BMC) 560 providing, among other features and services, an out-of-band management resource which may be coupled to a management server (not depicted). In at least some embodiments, BMC 560 may manage system 500 even when system 500 is powered off or powered to a standby state. BMC 560 may include a processor, memory, an out-of-band network interface separate from and physically isolated from an in-band network interface of system 500, and/or other embedded information handling resources. In certain embodiments, BMC 560 may include or may be an integral part of a remote access controller.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

All examples and conditional language recited herein are intended for pedagogical objects to aid the reader in understanding the disclosure and the concepts contributed by the inventor to furthering the art, and are construed as being without limitation to such specifically recited examples and conditions. Although embodiments of the present disclosure have been described in detail, it should be understood that various changes, substitutions, and alterations could be made hereto without departing from the spirit and scope of the disclosure.

What is claimed is:

1. A method, comprising:
performing initial phase operations to determine a value for an initial phase lending metric, wherein the initial phase operations include:
determining a funded-at-close (FAC) amount and a value-at-close (VAC) associated with a loan on a proposed project for a property; and
calculating the value for the initial phase lending metric based on the FAC and the VAC;
responsive to determining the initial phase lending metric satisfies an initial phase lending criteria, determining an after-repair-value (ARV) for the project;
performing one or more iterations of construction phase operations corresponding to one or more construct phase dates to determine one or values for a construction phase metric, wherein the construction phase operations include:
determining a funded to date (FTD) amount; and
calculating the value for the construction phase lending metric based on the FTD and the ARV; and
responsive to determining that none of the one or more construction phase lending metrics fails to satisfy a construction phase lending criteria, funding the loan.

2. The method of claim 1, wherein the loan comprises a non-qualifying mortgage (non-QM) new construction or fix and flip bridge loan for an owner-occupied property.

3. The method of claim 2, wherein the loan incorporates a living expense component providing for an owner's monthly living expense during the construction phase.

4. The method of claim 3, wherein the living expense component includes 12 months of prepaid rent and wherein the FAC reflects the 12 months or prepaid rent.

4. The method of claim 3, wherein the FTD reflects a pro rata percentage of the living expense component.

6. The method of claim 3, wherein the loan incorporate a collateral expense component including any one or more of:
a moving expense providing for an owner's moving expense before the construction phase;
a back taxes expense; and
a projection initiation expense.

7. The method of claim 6, wherein the FAC and FTD reflect the collateral expense component.

8. A system, comprising:
a processor;
a computer readable medium including processor-executable instructions that, when executed by the processor, cause the system to perform operations including:
performing initial phase operations to determine a value for an initial phase lending metric, wherein the initial phase operations include:
determining a funded-at-close (FAC) amount and a value-at-close (VAC) associated with a loan on a proposed project for a property; and
calculating the value for the initial phase lending metric based on the FAC and the VAC;
responsive to determining the initial phase lending metric satisfies an initial phase lending criteria, determining an after-repair-value (ARV) for the project;
performing one or more iterations of construction phase operations corresponding to one or more construct phase dates to determine one or values for a construction phase metric, wherein the construction phase operations include:
determining a funded to date (FTD) amount; and
calculating the value for the construction phase lending metric based on the FTD and the ARV; and
responsive to determining that none of the one or more construction phase lending metrics fails to satisfy a construction phase lending criteria, funding the loan.

9. The system of claim 8, wherein the loan comprises a non-qualifying mortgage (non-QM) new construction or fix and flip bridge loan for an owner-occupied property.

10. The system of claim 9, wherein the loan incorporates a living expense component providing for an owner's monthly living expense during the construction phase.

11. The system of claim 10, wherein the living expense component includes 12 months of prepaid rent and wherein the FAC reflects the 12 months or prepaid rent.

12. The system of claim 10, wherein the FTD reflects a pro rata percentage of the living expense component.

13. The system of claim 10, wherein the loan incorporates a collateral expense component including any one or more of:
a moving expense providing for an owner's moving expense before the construction phase;
a back taxes expense; and
a projection initiation expense.

14. The system of claim 13, wherein the FAC and FTD reflect the collateral expense component.

14. A non-transitory computer readable medium, comprising:
performing initial phase operations to determine a value for an initial phase lending metric, wherein the initial phase operations include:
determining a funded-at-close (FAC) amount and a value-at-close (VAC) associated with a loan on a proposed project for a property; and
calculating the value for the initial phase lending metric based on the FAC and the VAC;
responsive to determining the initial phase lending metric satisfies an initial phase lending criteria, determining an after-repair-value (ARV) for the project;
performing one or more iterations of construction phase operations corresponding to one or more construct phase dates to determine one or values for a construction phase metric, wherein the construction phase operations include:
determining a funded to date (FTD) amount; and
calculating the value for the construction phase lending metric based on the FTD and the ARV; and
responsive to determining that none of the one or more construction phase lending metrics fails to satisfy a construction phase lending criteria, funding the loan.

16. The non-transitory computer readable medium of claim 14, wherein the loan comprises a non-qualifying mortgage (non-QM) new construction or fix and flip bridge loan for an owner-occupied property.

17. The non-transitory computer readable medium of claim 16, wherein the loan incorporates a living expense component providing for an owner's monthly living expense during the construction phase.

18. The non-transitory computer readable medium of claim 17, wherein the living expense component includes 12 months of prepaid rent and wherein the FAC reflects the 12 months or prepaid rent.

19. The non-transitory computer readable medium of claim 17, wherein the FTD reflects a pro rata percentage of the living expense component.

20. The non-transitory computer readable medium of claim 17, wherein the loan incorporate a collateral expense component including any one or more of:
a moving expense providing for an owner's moving expense before the construction phase;
a back taxes expense; and
a projection initiation expense.
